(19) United States
(12) Patent Application Publication
(10) Pub. No.: US 2026/0009496 A1
(43) Pub. Date: Jan. 8, 2026

(54) SUPPORTING DEVICE

(71) Applicant: SYNCMOLD ENTERPRISE CORP., New Taipei City (TW)

(72) Inventors: Wen-Chen Liu, New Taipei City (TW); Kuang-Po Chen, New Taipei City (TW); Kuo-Yuan Chou, New Taipei City (TW); Yen-Ting Sun, New Taipei City (TW); Wei-Shen Weng, New Taipei City (TW)

(21) Appl. No.: 19/194,093

(22) Filed: Apr. 30, 2025

Related U.S. Application Data
(60) Provisional application No. 63/668,066, filed on Jul. 5, 2024.

(30) Foreign Application Priority Data
Mar. 7, 2025 (TW) 114108545

(51) Int. Cl. F16M 11/12; A47B 97/00

(52) U.S. Cl. CPC F16M 11/121; A47B 97/001

(57) ABSTRACT

A supporting device is provided and comprises: a fixing module including at least one left outer pivot portion and at least one right outer pivot portion; a carrying module including at least one left inner pivot portion and at least one right inner pivot portion; at least one left outer shell member pivotally connected to the left outer pivot portion and including two left rail portions corresponding to each other; at least one left inner shell member slidably disposed on the left rail portions and pivotally connected to the left inner pivot portion; at least one right outer shell member pivotally connected to the right outer pivot portion and including two right rail portions corresponding to each other; and at least one right inner shell member is slidably disposed on the right rail portions and pivotally connected to the right inner pivot portion.

### CROSS-REFERENCE TO RELATED APPLICATIONS

This application claims the benefit of U.S. Provisional Application Ser. No. 63/668,066 filed on Jul. 5, 2024, and the benefit of Taiwan Patent Application Serial No. 114108545 filed on Mar. 7, 2025. The entirety of each Application is incorporated herein by reference.

### BACKGROUND

### 1. Technical Field

The present disclosure relates to a supporting device, and more particularly, to a supporting device with a thin overall structure.

### 2. Description of Related Art

The Taiwan Patent No. M630456 describes a wall mount comprising a hanging bracket, a first telescoping bracket, a second telescoping bracket, and a supporting bracket. The hanging bracket is disposed on a wall, the first telescopic bracket is disposed on the hanging bracket, the second telescopic bracket is disposed on the first telescopic bracket, the supporting bracket is disposed on the second telescopic bracket, and a display is mounted on the supporting bracket. The first telescopic bracket and the second telescopic bracket are formed by two connecting rods cross-connected to form an X-shaped connecting rod that can be opened and closed, so that the first telescopic bracket and the second telescopic bracket can be opened, closed and telescoped.

However, the aforementioned X-shaped connecting rod still occupies a certain space when retracted, and the structure of the X-shaped connecting rod cannot effectively thin the wall mount, so that the display obviously protrudes from the wall, thereby causing a visual abruptness.

### SUMMARY

The present disclosure provides a supporting device for carrying a display on a work surface, the display defining a screen normal line and the work surface defining a central normal line, the supporting device comprises: a fixing module fixedly connected to the work surface, and including at least one left outer pivot portion and at least one right outer pivot portion, wherein the left outer pivot portion defines a left outer axis, and the right outer pivot portion defines a right outer axis; a carrying module configured for carrying the display, and including at least one left inner pivot portion and at least one right inner pivot portion, wherein the left inner pivot portion defines a left inner axis, and the right inner pivot portion defines a right inner axis; at least one left outer shell member pivotally connected to the left outer pivot portion, pivoting relative to the fixing module around the left outer axis, and including two left rail portions corresponding to each other; at least one left inner shell member slidably disposed on the left rail portions, pivotally connected to the left inner pivot portion, and pivoting relative to the carrying module around the left inner axis, wherein a left overlapping region is defined between the left inner shell member and the left outer shell member; at least one right outer shell member pivotally connected to the right outer pivot portion, pivoting relative to the fixing module around the right outer axis, and including two right rail portions corresponding to each other; and at least one right inner shell member slidably disposed on the right rail portions, pivotally connected to the right inner pivot portion, and pivoting relative to the carrying module around the right inner axis, wherein a right overlapping region is defined between the right inner shell member and the right outer shell member; wherein the carrying module is able to change between an outstretched state and a retracted state, in the retracted state, the carrying module is closest to the fixing module, and the left overlapping region and the right overlapping region are largest, and the screen normal line is parallel to or overlaps the central normal line, and wherein in the outstretched state, the carrying module is farthest from the fixing module, the left overlapping region and the right overlapping region are smallest, and the screen normal line is parallel to or overlaps the central normal line.

In the aforementioned supporting device, in a case where the screen normal line keeps to be parallel to or overlap the central normal line, when the carrying module changes from the retracted state to the outstretched state, the carrying module gradually moves away from the fixing module, and the left overlapping region and the right overlapping region gradually become smaller, and when the carrying module changes from the outstretched state to the retracted state, the carrying module gradually approaches the fixing module, and the left overlapping region and the right overlapping region gradually become larger.

In the aforementioned supporting device, in a case where the screen normal line keeps to be parallel to or overlap the central normal line, an area of the left overlap region is the same as an area of the right overlap region.

In the aforementioned supporting device, by making the area of the left overlapping region different from the area of the right overlapping region, an included angle is formed between the screen normal line and the central normal line of the work surface, and the greater a difference between the area of the left overlapping region and the area of the right overlapping region, the greater the included angle.

In the aforementioned supporting device, when the area of the left overlapping region is larger than the area of the right overlapping region, the display is relatively adjacent to the left outer pivot portion and away from the right outer pivot portion, and when the area of the left overlapping region is smaller than the area of the right overlapping region, the display is relatively away from the left outer pivot portion and adjacent to the right outer pivot portion.

In the aforementioned supporting device, the left outer shell member further includes a left stop post, the left inner shell member includes a left limiting through slot, the left stop post is slidably disposed in the left limiting through slot, and the right outer shell member further includes a right stop post, and the right inner shell member includes a right limiting through slot, and the right stop post is slidably disposed in the right limiting through slot.

In the aforementioned supporting device, the left limiting through slot has a left head end and a left tail end opposite to each other, and the right limiting through slot has a right head end and a right tail end opposite to each other, wherein when the carrying module is in the retracted state, the left stop post abuts against the left head end, and the right stop post abuts against the right head end, and wherein when the carrying module is in the outstretched state, the left stop post abuts against the left tail end, and the right stop post abuts against the right tail end.

In the aforementioned supporting device, the left inner shell member further includes two left sliding blocks and two left wing plates spaced apart from each other, the left sliding blocks are respectively sleeved on the left wing plates and respectively slidably disposed on the left rail portions, and wherein the right inner shell member further includes two right sliding blocks and two right wing plates spaced apart from each other, the right sliding blocks are respectively sleeved on the right wing plates and respectively slidably disposed on the right rail portions.

In the aforementioned supporting device, the left outer shell member further includes a left outer main plate and a left outer pivot joint, the left outer pivot joint is disposed at one end of the left outer main plate and is pivotally connected to the left outer pivot portion, the left rail portions are formed by extending outwards and bending from opposite sides of the left outer main plate respectively, and the left stop post is disposed on the left outer main plate, and wherein the right outer shell member further includes a right outer main plate and a right outer pivot joint, the right outer pivot joint is disposed at one end of the right outer main plate and is pivotally connected to the right outer pivot portion, the right rail portions are formed by extending outwards and bending from opposite sides of the right outer main plate respectively, and the right stop post is disposed on the right outer main plate.

In the aforementioned supporting device, the left inner shell member further includes a left inner main plate and a left inner pivot joint, the left inner pivot joint is disposed at one end of the left inner main plate and is pivotally connected to the left inner pivot portion, the left wing plates are formed by extending outward from opposite sides of the left inner main plate respectively, and the left limit through slot is formed through the left inner main plate and is located between the left wing plates, and wherein the right inner shell member further includes a right inner main plate and a right inner pivot joint, the right inner pivot joint is disposed at one end of the right inner main plate and is pivotally connected to the right inner pivot portion, the right wing plates are formed by extending outward from opposite sides of the right inner main plate respectively, and the right limiting through slot is formed through the right inner main plate and is located between the right wing plates.

In the aforementioned supporting device, the fixing module further includes a plurality of outer pivot rods, the carrying module further includes a plurality of inner pivot rods, the outer pivot rods are respectively disposed to pass through the left outer pivot portion and the left outer pivot joint along the left outer axis or disposed to pass through the right outer pivot portion and the right outer pivot joint along the right outer axis, and wherein the inner pivot rods are respectively disposed to pass through the left inner pivot portion and the left inner pivot joint along the left inner axis or disposed to pass through the right inner pivot portion and the right inner pivot joint along the right inner axis.

In the aforementioned supporting device, the carrying module further includes a central main plate and two carrying plates, the left inner pivot portion and the right inner pivot portion are respectively disposed on the opposite left and right sides of the central main plate, and the carrying plates are respectively disposed on upper and lower sides of the central main plate and are used to carry the display.

In the aforementioned supporting device, the central main plate and the carrying plates form an H-shape.

In the aforementioned supporting device, the fixing module further includes two fixing main plates, a left connecting plate and a right connecting plate, the fixing main plates are spaced from each other and fixed to the work surface, the left connecting plate is respectively connected to left ends of the fixing main plate, the left outer pivot portion is disposed on the left connecting plate, the right connecting plate is respectively connected to right ends of the fixing main plate, and the right outer pivot portion is disposed on the right connecting plate.

In the aforementioned supporting device, the fixing main plates, the left connecting plate, the right connecting plate, the central main plate, the carrying plates, the left outer shell member, the left inner shell member, the right outer shell member and the right inner shell member are made of metal.

To sum up, in the supporting device of the present disclosure, the fixing main plates, the left connecting plate, the right connecting plate, the central main plate, the carrying plates, the left outer shell members, the left inner shell members, the right outer shell members and the right inner shell members are plated, which can effectively reduce the thickness and enable the display to be close to the wall.

### BRIEF DESCRIPTION OF THE DRAWINGS

FIG. 1 is an overall schematic view of a supporting device according to the present disclosure.

FIG. 2 is an exploded schematic view of the supporting device according to the present disclosure.

FIG. 3 and FIG. 4 are exploded schematic views of some components of the supporting device according to the present disclosure.

FIG. 5 is a front view of the supporting device according to the present disclosure in a retracted state.

FIG. 6 is an overall schematic view of the supporting device according to the present disclosure in an outstretched state.

FIG. 7 is a front view of the supporting device according to the present disclosure in the outstretched state.

FIG. 8 is a schematic view of the supporting device according to the present disclosure rotating to the left in the outstretched state.

FIG. 9 is a schematic view of the supporting device according to the present disclosure rotating to the right in the outstretched state.

### DETAILED DESCRIPTION

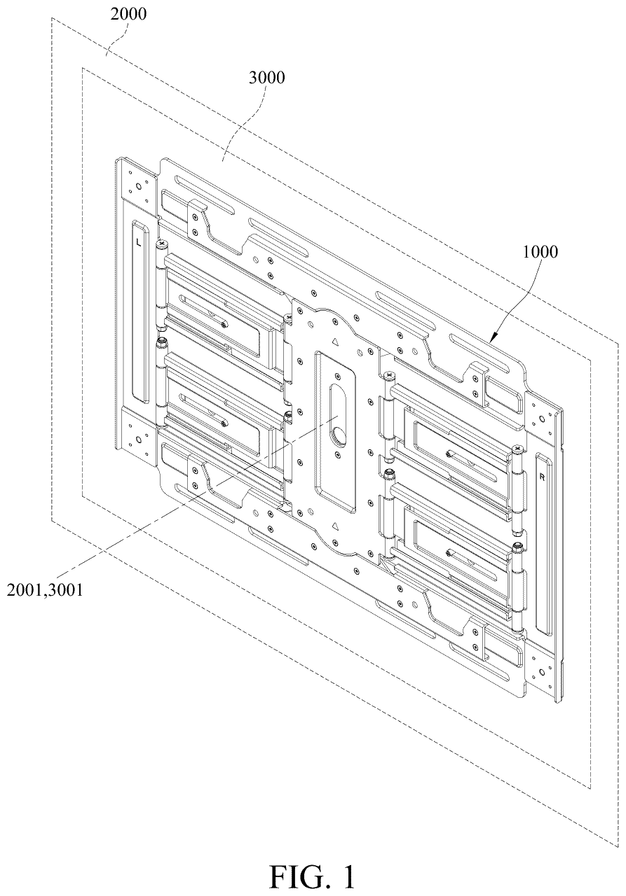

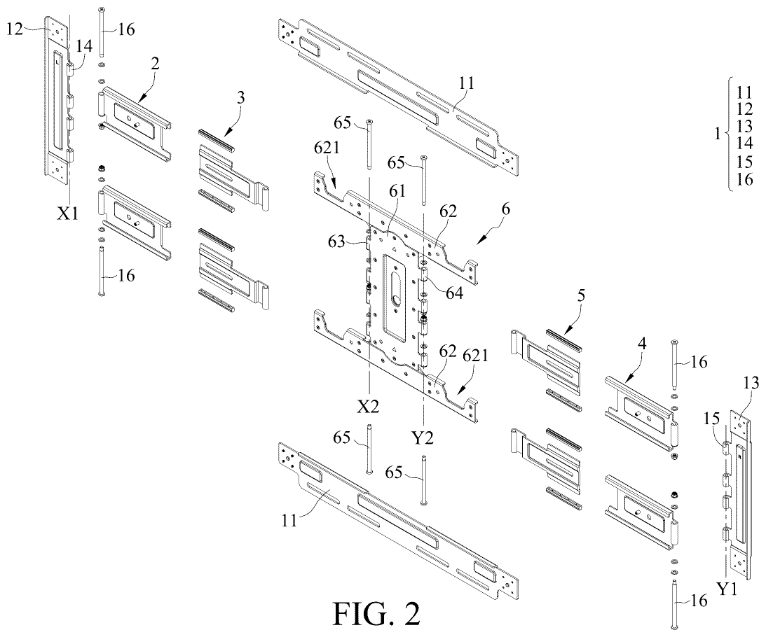

Referring to FIG. 1 and FIG. 2, a supporting device 1000 is used to carry a display 2000 on a work surface 3000 (e.g., a wall). The supporting device 1000 comprises a fixing module 1, two left outer shell members 2, two left inner shell members 3, two right outer shell members 4, two right inner shell members 5 and a carrying module 6. The fixing module 1 is fixed to the work surface 3000, the left outer shell members 2 are pivotally connected to one side of the fixing module 1, the left inner shell members 3 are slidably disposed in the left outer shell members 2 and are pivotally connected to one side of the carrying module 6, the right outer shell members 4 are pivotally connected to the other side of the fixing module 1, and the right inner shell members 5 are slidably disposed on the right outer shell members 4 and are pivotally connected to the other side of the carrying module 6. The structures of the components and the connection relationship between them will be described in detail below. The display 2000 defines a screen normal line 2001, and the work surface 3000 defines a central normal line 3001.

The fixing module 1 includes two fixing main plates 11, a left connecting plate 12, a right connecting plate 13, four left outer pivot portions 14, four right outer pivot portions 15 and four outer pivot rods 16. The fixing main plates 11 are each roughly in the form of a long striped plate body, and are fixed to the work surface 3000 and spaced from each other. The left connecting plate 12 is roughly in the shape of a long striped plate body, and has two ends connected to the left ends of the fixing main plates 11, respectively. The right connecting plate 13 is roughly in the shape of a long striped plate body, and has two ends connected to the right ends of the fixing main plates 11, respectively. The fixing main plates 11, the left connecting plate 12 and the right connecting plate 13 after being assembled are generally in the form of a square frame. The left outer pivot portions 14 are spaced from each other, are formed by extending outward and bending from one side of the left connecting plate 12 to have a C-shaped cross section. The center of the C-shaped cross-section of each of the left outer pivot portions 14 may define a left outer axis X1. The right outer pivot portions 15 are spaced apart from each other, are formed by extending outward and bending from one side of the right connecting plate 13 to have a C-shaped cross section. The center of the C-shaped cross section of each of the right outer pivot portions 15 may define a right outer axis Y1.

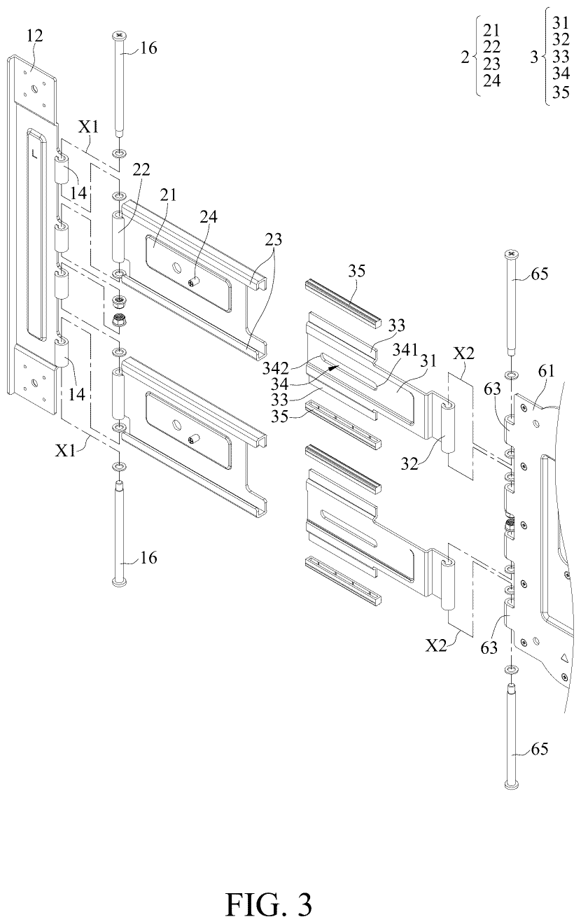

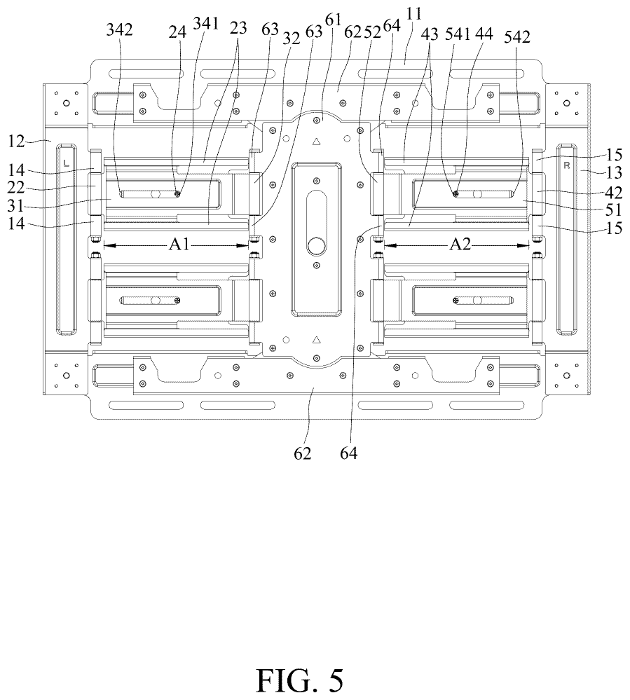

Please refer to FIG. 3 and FIG. 5. Each of the left outer shell members 2 includes a left outer main plate 21, a left outer pivot joint 22, two left rail portions 23 and a left stop post 24. The left outer main plate 21 is roughly in the shape of a rectangular plate body. The left outer pivot joint 22 is formed by extending outward and bending from the left end of the left outer main plate 21 to have a C-shaped cross section, and is disposed between any two of the left outer pivot portions 14. The left rail portions 23 are respectively formed by extending outward and bending from the upper and lower sides of the left outer main plate 21 to have a U-shaped cross section, and the left rail portions 23 correspond to each other. The left stop post 24 (such as a screw) is protruded from the left outer main plate 21 and is located between the left rail portions 23.

Each of the left inner shell members 3 includes a left inner main plate 31, a left inner pivot joint 32, two left wing plates 33, a left limiting through slot 34 and two left sliding blocks 35. The left inner main plate 31 is roughly in the shape of a rectangular plate body. The left inner pivot joint 32 is formed by extending outward and bending from the right end of the left inner main plate 31 to have a C-shaped cross section. The left wing plates 33 are formed by extending outward from the upper and lower sides of the left inner main plate 31, respectively, so that the left inner main plate 31, the left inner pivot joint 32 and the left wing plates 33 are roughly T-shaped. The left limiting through slot 34 is formed through the left inner main plate 31 and is located between the left wing plates 33, and has a left head end 341 and a left tail end 342 opposite to each other. The left sliding blocks 35 are respectively sleeved on the left wing plates 33 and slidably disposed on the left rail portions 23, and the left stop posts 24 are slidably disposed in the left limiting through slots 34. In this way, the left inner shell members 3 can move left and right relative to the left outer shell members 2 without being separated from each other, and a left overlapping region A1 can be defined between the left outer shell members 2 and the left inner shell members 3. In one embodiment, the left sliding blocks 35 are made of polyoxymethylene (POM).

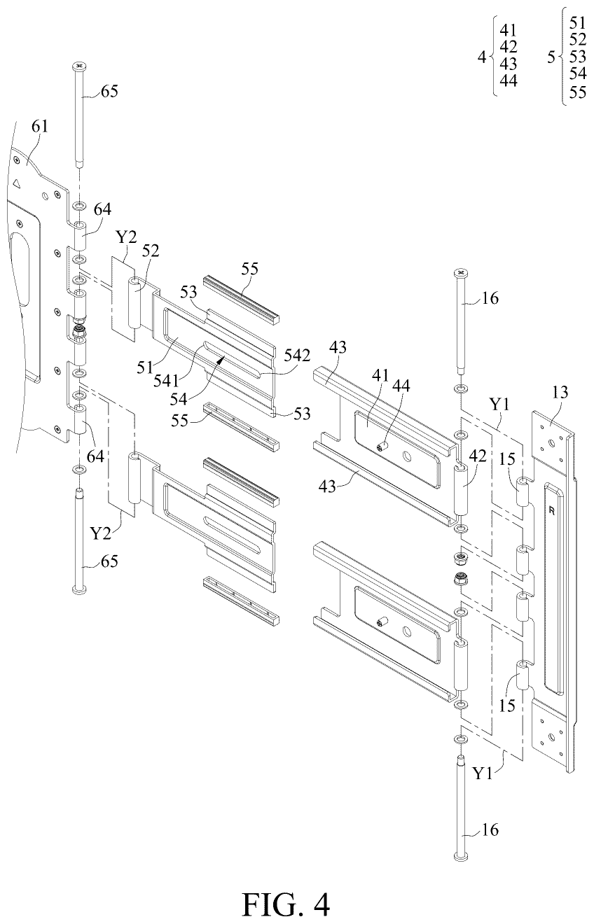

Please refer to FIG. 4 and FIG. 5. Each of the right outer shell members 4 includes a right outer main plate 41, a right outer pivot joint 42, two right rail portions 43 and a right stop post 44. The right outer main plate 41 is roughly in the shape of a rectangular plate body. The right outer pivot joint 42 is formed by extending outward and bending from the right end of the right outer main plate 41 to have a C-shaped cross section, and is disposed between any two of the right outer pivot portions 15. The right rail portions 43 are respectively formed by extending outward and bending from the upper and lower sides of the right outer main plate 41 to have a U-shaped cross section, and the right rail portions 43 correspond to each other. The right stop post 44 (such as a screw) is protruded from the right outer main plate 41 and is located between the right rail portions 43.

Each of the right inner shell members 5 includes a right inner main plate 51, a right inner pivot joint 52, two right wing plates 53, a right limiting through slot 54 and two right sliding blocks 55. The right inner main plate 51 is roughly in the shape of a rectangular plate body. The right inner pivot joint 52 is formed by extending outward and bending from the left end of the right inner main plate 51 to have a C-shaped cross section. The right wing plates 53 are formed by extending outward from the upper and lower sides of the right inner main plate 51, respectively, so that the right inner main plate 51, the right inner pivot joint 52 and the right wing plates 53 are roughly T-shaped. The right limiting through slot 54 is formed through the right inner main plate 51 and is located between the right wing plates 53, and has a right head end 541 and a right tail end 542 opposite to each other. The right sliding blocks 55 are respectively sleeved on the right wing plates 53 and slidably disposed on the right rail portions 43, and the right stop posts 44 are slidably disposed in the right limiting through slots 54. In this way, the right inner shell members 5 can move left and right relative to the right outer shell members 4 without being separated from each other, and a right overlapping region A2 can be defined between the right outer shell members 4 and the right inner shell members 5. In one embodiment, the right sliding blocks 55 are made of polyoxymethylene (POM).

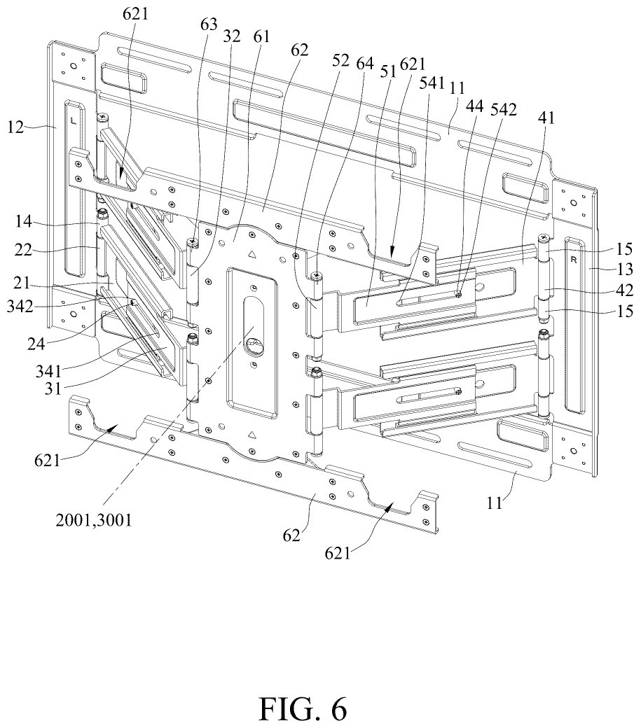

The carrying module 6 is used to carry the display 2000 and includes a central main plate 61, two carrying plates 62, four left inner pivot portions 63, four right inner pivot portions 64 and four inner pivot rods 65. The central main plate 61 is roughly in the shape of a rectangular plate body. The carrying plates 62 are generally in the shape of a long striped plate body and are disposed on the upper and lower sides of the central main plate 61, respectively, thereby forming an H-shape. Each of the carrying plates 62 has two recessed portions 621 (see FIG. 6). The back of the display 2000 can be fastened with screws, so that the display 2000 can be mounted on the carrying module 6 by engaging the screws with the recessed portions 621. Furthermore, a safety screw may be passed through the central main plate 61 and then locked to the back of the display 2000 to prevent the display 2000 from falling off.

The left inner pivot portions 63 are spaced from each other and are formed by extending outward and bending from the left side of the central main plate 61 to have a C-shaped cross section. The center of the C-shaped cross section of each of the left inner pivot portions 63 may define a left inner axis X2. The left inner pivot joint 32 of each of the left inner shell members 3 is disposed between any two of the left inner pivot portions 63. The right inner pivot portions 64 are spaced from each other and are formed by extending outward and bending from the right side of the central main plate 61 to have a C-shaped cross section. The center of the C-shaped cross-section of each of the right inner pivot portions 64 may define a right inner axis Y2. The right inner pivot joint 52 of each of the right inner shell members 5 is disposed between any two of the right inner pivot portions 64.

Two of the outer pivot rods 16 are disposed to pass through the left outer pivot portions 14 and the left outer pivot joints 22 along the left outer axis X1, respectively, so that the left outer shell members 2 can be pivotally connected to the left outer pivot portions 14. As a result, the left outer shell members 2 can pivot relative to the left connecting plate 12 around the left outer axis X1. The other two of the outer pivot rods 16 are disposed to pass through the right outer pivot portions 15 and the right outer pivot joints 42 along the right outer axis Y1, respectively, so that the right outer shell members 4 can be pivotally connected to the right outer pivot portions 15. As a result, the right outer shell members 4 can pivot relative to the right connecting plate 13 around the right outer axis Y1. Two of the inner pivot rods 65 are disposed to pass through the left inner pivot portions 63 and the left inner pivot joints 32 along the left inner axis X2, respectively, so that the left inner shell members 3 can be pivotally connected to the left inner pivot portions 63. As a result, the left inner shell members 3 can pivot relative to the central main plate 61 around the left inner axis X2. The other two of the inner pivot rods 65 are disposed to pass through the right inner pivot portions 64 and the right inner pivot joints 52 along the right inner axis Y2, respectively, so that the right inner shell members 5 can be pivotally connected to the right inner pivot portions 64. As a result, the right inner shell members 5 can pivot relative to the central main plate 61 around the right inner axis Y2. In one embodiment, the outer pivot rods 16 and the inner pivot rods 65 are screw rods respectively, and can be fixed with nuts and washers, which will not be described in detail.

The above embodiments are described by taking the example that the left outer shell member 2, the left inner shell member 3, the right outer shell member 4 and the right inner shell member 5 each has two, and the left outer pivot portion 14, the right outer pivot portion 15, the left inner pivot portion 63 and the right inner pivot portion 64 each has four, but the present disclosure is not limited to as such. The number of the left outer shell member 2, the left inner shell member 3, the right outer shell member 4 and the right inner shell member 5 can be designed according to the requirements, and the number of the left outer pivot portion 14, the right outer pivot portion 15, the left inner pivot portion 63, and the right inner pivot portion 64 may also be adjusted accordingly.

In one embodiment, the fixing main plate 11, the left connecting plate 12, the right connecting plate 13, the central main plate 61, the carrying plate 62, the left outer shell member 2, the left inner shell member 3, the right outer shell member 4 and the right inner shell member 5 are made of metal (for example, iron respectively).

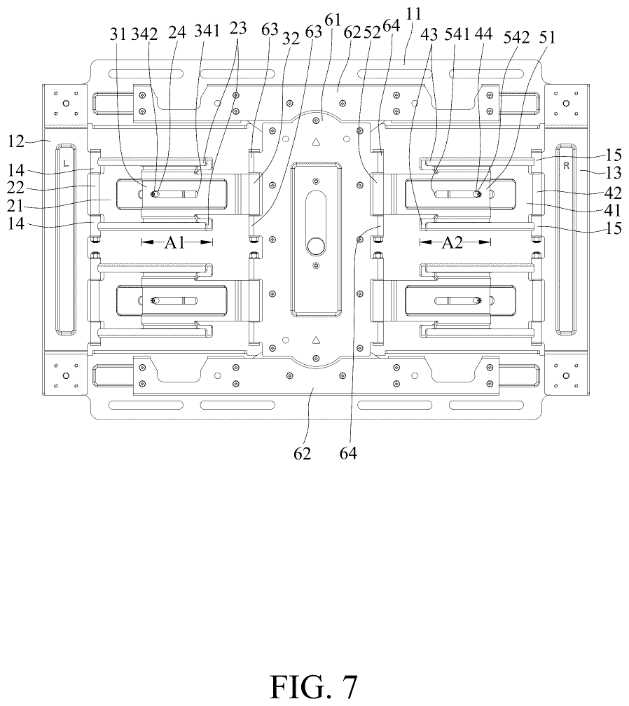

The following describes the operation of the supporting device 1000 disclosed herein. In the case where the screen normal line 2001 is keeps to be parallel to or overlap the central normal line 3001, the carrying module 6 can move forward and backward along the central normal line 3001 of the work surface 3000, so that the carrying module 6 can be changed between a retracted state (as shown in FIG. 5) and an outstretched state (as shown in FIG. 6 and FIG. 7). When the carrying module 6 is in the retracted state, the carrying module 6 is closest to the fixing module 1, the carrying plates 62 are respectively attached to the fixing main plates 11, the central main plate 61 is located at the center of the fixing main plate 11, the left connecting plate 12 and the right connecting plate 13, and the central main plate 61, the left outer shell members 2, the left inner shell members 3, the right outer shell members 4 and the right inner shell members 5 are roughly flush with the fixing main plates 11, the left connecting plate 12 and the right connecting plate 13. At this time, the left stop posts 24 abut against the left head ends 341 of the left limiting through slots 34, and the right stop posts 44 abut against the right head ends 541 of the right limiting through slots 54. The left inner shell members 3 are completely accommodated in the left outer shell members 2, so that an area of the left overlapping region A1 is the largest. The right inner shell members 5 are completely accommodated in the right outer shell members 4, so that an area of the right overlapping region A2 is the largest.

When the carrying module 6 changes from the retracted state to the outstretched state, the carrying module 6 moves along the central normal line 3001 of the work surface 3000 and gradually moves away from the fixing module 1. The left outer shell members 2 can pivot relative to the left connecting plate 12 around the left outer axis X1, and the left inner shell members 3 can pivot relative to the central main plate 61 around the left inner axis X2, so that the left outer shell members 2 and the left inner shell members 3 can move relative to each other. The left inner shell members 3 gradually extend out of the left outer shell members 2, and the area of the left overlapping region A1 gradually decreases until the left stop posts 24 abut against the left tail ends 342 of the left limiting through slots 34. Similarly, the right outer shell members 4 can pivot relative to the right connecting plate 13 around the right outer axis Y1, and the right inner shell members 5 can pivot relative to the central main plate 61 around the right inner axis Y2, so that the right outer shell members 4 and the right inner shell members 5 can move relative to each other. The right inner shell members 5 gradually extend out of the right outer shell members 4, and the area of the right overlapping region A2 gradually decreases until the right stop posts 44 abut against the right tail ends 542 of the right limiting through slots 54. When the left stop posts 24 and right stop posts 44 abut against the left tail ends 342 and the right tail ends 542 respectively, the carrying module 6 is in the outstretched state. At this time, the carrying module 6 is farthest from the fixing module 1, the area of the left overlapping region A1 is the smallest, and the area of the right overlapping region A2 is the smallest.

To change the carrying module 6 from the outstretched state to the retracted state, the carrying module 6 is simply moved along the central normal line 3001 of the work surface 3000 toward the fixing module 1. The left inner shell members 3 gradually retract into the left outer shell members 2, and the area of the left overlapping region A1 gradually increase until the left stop posts 24 abut against the left head ends 341 of the left limit through slots 34. The right inner shell members 5 gradually retract into the right outer shell members 4, and the area of the right overlapping region A2 gradually increase until the right stop posts 44 abut against the right head ends 541 of the right limiting through slots 54. In addition, in the above process of this embodiment (i.e., the screen normal line 2001 is always parallel to or overlaps the central normal line 3001), the area of the left overlapping region A1 is the same as the area of the right overlapping region A2, but the present disclosure is not limited to as such.

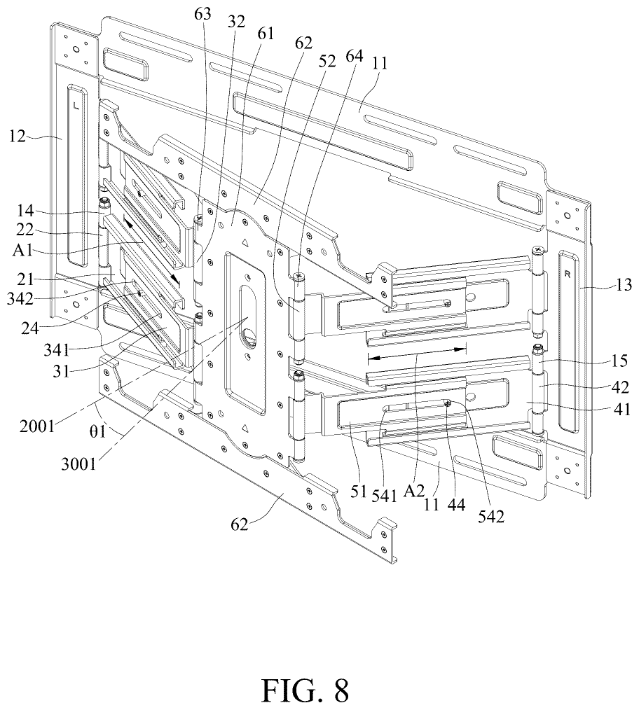

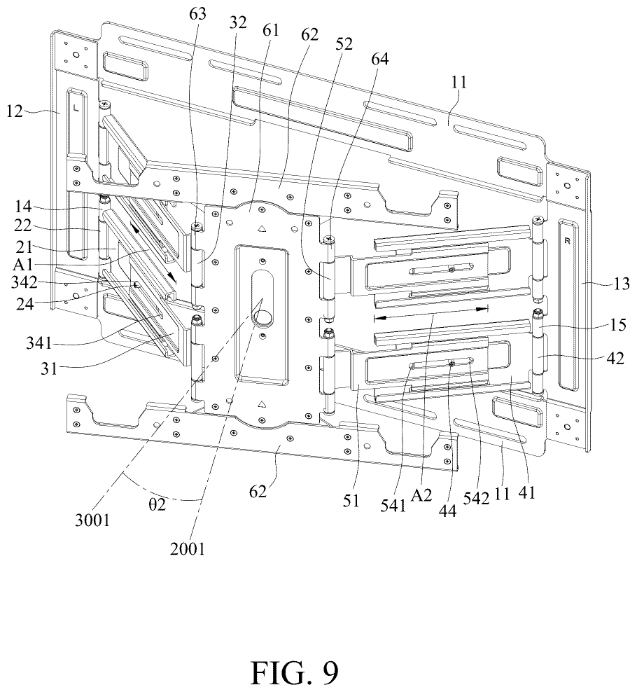

When the carrying module 6 is in the outstretched state, the supporting device 1000 presents a three-bar mechanism, and the user can further freely rotate the display 2000 horizontally to left and right. For example, as shown in FIG. 8, when the right stop posts 44 are fixed at positions abutting against the right tail ends 542, the display 2000 can be rotated to the left. The left stop posts 24 move toward the left head ends 341 and away from the left tail ends 342, and the left inner shell members 3 partially retract into the left outer shell members 2. The area of the left overlapping region A1 gradually increases, while the area of the right overlapping region A2 remains unchanged. That is, the area of the left overlapping region A1 is larger than the area of the right overlapping region A2. At this time, the screen normal line 2001 of the display 2000 and the central normal line 3001 of the work surface 3000 form an included angle θ1, and the display 2000 is relatively close to the left outer pivot portions 14 and away from the right outer pivot portions 15. A magnitude of the included angle θ1 is determined by a difference between the area of the left overlapping region A1 and the area of the right overlapping region A2. The larger the difference in area, the larger the included angle θ1. Similarly, as shown in FIG. 9, when the left stop posts 24 are fixed at positions abutting against the left tail ends 342, the display 2000 can be rotated to the right. The right stop posts 44 move toward the right head ends 541 and away from the right tail ends 542, and the right inner shell members 5 partially retract into the right outer shell members 4. The area of the right overlapping region A2 gradually increases, while the area of the left overlapping region A1 remains unchanged. That is, the area of the left overlapping region A1 is smaller than the area of the right overlapping region A2. At this time, the screen normal line 2001 of the display 2000 and the central normal line 3001 of the work surface 3000 form an included angle θ2, and the display 2000 is relatively away from the left outer pivot portions 14 and close to the right outer pivot portions 15. Similarly, a magnitude of the included angle θ2 is determined by a difference between the area of the left overlapping region A1 and the area of the right overlapping region A2.

To sum up, in the supporting device of the present disclosure, the fixing main plates, the left connecting plate, the right connecting plate, the central main plate, the carrying plates, the left outer shell members, the left inner shell members, the right outer shell members and the right inner shell members are plated, which can effectively reduce the thickness and enable the display to be close to the wall.

What is claimed is:

1. A supporting device for carrying a display on a work surface, the display defining a screen normal line and the work surface defining a central normal line, the supporting device comprising:
a fixing module fixedly connected to the work surface, and including at least one left outer pivot portion and at least one right outer pivot portion, wherein the left outer pivot portion defines a left outer axis and the right outer pivot portion defines a right outer axis;
a carrying module configured for carrying the display, and including at least one left inner pivot portion and at least one right inner pivot portion, wherein the left inner pivot portion defines a left inner axis and the right inner pivot portion defines a right inner axis;
at least one left outer shell member pivotally connected to the left outer pivot portion, being able to pivot relative to the fixing module around the left outer axis, and including two left rail portions corresponding to each other;
at least one left inner shell member slidably disposed on the left rail portions, pivotally connected to the left inner pivot portion, and being able to pivot relative to the carrying module around the left inner axis, wherein a left overlapping region is defined between the left inner shell member and the left outer shell member;
at least one right outer shell member pivotally connected to the right outer pivot portion, being able to pivot relative to the fixing module around the right outer axis, and including two right rail portions corresponding to each other; and
at least one right inner shell member slidably disposed on the right rail portions, pivotally connected to the right inner pivot portion, and being able to pivot relative to the carrying module around the right inner axis, wherein a right overlapping region is defined between the right inner shell member and the right outer shell member;
wherein the carrying module is able to change between an outstretched state and a retracted state, wherein in the retracted state, the carrying module is closest to the fixing module, and the left overlapping region and the right overlapping region are largest, and the screen normal line is parallel to or overlaps the central normal line, and wherein in the outstretched state, the carrying module is farthest from the fixing module, the left overlapping region and the right overlapping region are smallest, and the screen normal line is parallel to or overlaps the central normal line.

2. The supporting device of claim 1, wherein, in a case where the screen normal line keeps to be parallel to or overlap the central normal line, when the carrying module changes from the retracted state to the outstretched state, the carrying module gradually moves away from the fixing module, and the left overlapping region and the right overlapping region gradually become smaller, and when the carrying module changes from the outstretched state to the retracted state, the carrying module gradually approaches the fixing module, and the left overlapping region and the right overlapping region gradually become larger.

3. The supporting device of claim 2, wherein, in a case where the screen normal line keeps to be parallel to or overlap the central normal line, an area of the left overlap region is the same as an area of the right overlap region.

4. The supporting device of claim 3, wherein by making the area of the left overlapping region different from the area of the right overlapping region, an included angle is formed between the screen normal line and the central normal line of the work surface, and the greater a difference between the area of the left overlapping region and the area of the right overlapping region is, the greater the included angle will be.

5. The supporting device of claim 4, wherein when the area of the left overlapping region is larger than the area of the right overlapping region, the display is relatively adjacent to the left outer pivot portion and away from the right outer pivot portion, and when the area of the left overlapping region is smaller than the area of the right overlapping region, the display is relatively away from the left outer pivot portion and adjacent to the right outer pivot portion.

6. The supporting device of claim 5, wherein the left outer shell member further includes a left stop post, the left inner shell member includes a left limiting through slot, and the left stop post is slidably disposed in the left limiting through slot, and wherein the right outer shell member further includes a right stop post, the right inner shell member includes a right limiting through slot, and the right stop post is slidably disposed in the right limiting through slot.

7. The supporting device of claim 6, wherein the left limiting through slot has a left head end and a left tail end opposite to each other, and the right limiting through slot has a right head end and a right tail end opposite to each other, wherein when the carrying module is in the retracted state, the left stop post abuts against the left head end and the right stop post abuts against the right head end, and wherein when the carrying module is in the outstretched state, the left stop post abuts against the left tail end and the right stop post abuts against the right tail end.

8. The supporting device of claim 7, wherein the left inner shell member further includes two left sliding blocks and two left wing plates spaced apart from each other, the left sliding blocks are respectively sleeved on the left wing plates and respectively slidably disposed on the left rail portions, and wherein the right inner shell member further includes two right sliding blocks and two right wing plates spaced apart from each other, the right sliding blocks are respectively sleeved on the right wing plates and respectively slidably disposed on the right rail portions.

9. The supporting device of claim 8, wherein the left outer shell member further includes a left outer main plate and a left outer pivot joint, the left outer pivot joint is disposed at one end of the left outer main plate and is pivotally connected to the left outer pivot portion, the left rail portions are formed by extending outwards and bending from opposite sides of the left outer main plate respectively, and the left stop post is disposed on the left outer main plate, and wherein the right outer shell member further includes a right outer main plate and a right outer pivot joint, the right outer pivot joint is disposed at one end of the right outer main plate and is pivotally connected to the right outer pivot portion, the right rail portions are formed by extending outwards and bending from opposite sides of the right outer main plate respectively, and the right stop post is disposed on the right outer main plate.

10. The supporting device of claim 9, wherein the left inner shell member further includes a left inner main plate and a left inner pivot joint, the left inner pivot joint is disposed at one end of the left inner main plate and is pivotally connected to the left inner pivot portion, the left wing plates extend outward from opposite sides of the left inner main plate respectively, and the left limit through slot is formed through the left inner main plate and is located between the left wing plates, and wherein the right inner shell member further includes a right inner main plate and a right inner pivot joint, the right inner pivot joint is disposed at one end of the right inner main plate and is pivotally connected to the right inner pivot portion, the right wing plates extend outward from opposite sides of the right inner main plate respectively, and the right limiting through slot is formed through the right inner main plate and is located between the right wing plates.

11. The supporting device of claim 10, wherein the fixing module further includes a plurality of outer pivot rods, the carrying module further includes a plurality of inner pivot rods, the outer pivot rods are respectively disposed to pass through the left outer pivot portion and the left outer pivot joint along the left outer axis or disposed to pass through the right outer pivot portion and the right outer pivot joint along the right outer axis, and wherein the inner pivot rods are respectively disposed to pass through the left inner pivot portion and the left inner pivot joint along the left inner axis or disposed to pass through the right inner pivot portion and the right inner pivot joint along the right inner axis.

12. The supporting device of claim 1, wherein the carrying module further includes a central main plate and two carrying plates, the left inner pivot portion and the right inner pivot portion are respectively disposed on left and right sides of the central main plate, and the carrying plates are respectively disposed on upper and lower sides of the central main plate and are used to carry the display.

13. The supporting device of claim 12, wherein the central main plate and the carrying plates form an H-shape.

14. The supporting device of claim 13, wherein the fixing module further includes two fixing main plates, a left connecting plate and a right connecting plate, the fixing main plates are spaced from each other and fixed to the work surface, the left connecting plate is respectively connected to left ends of the fixed main plates, the left outer pivot portion is disposed on the left connecting plate, the right connecting plate is respectively connected to right ends of the fixed main plates, and the right outer pivot portion is disposed on the right connecting plate.

15. The supporting device of claim 14, wherein the fixing main plates, the left connecting plate, the right connecting plate, the central main plate, the carrying plates, the left outer shell member, the left inner shell member, the right outer shell member and the right inner shell member are made of metal.
